(19) United States
(12) Patent Application Publication
(10) Pub. No.: US 2025/0067013 A1
(43) Pub. Date: Feb. 27, 2025

(54) Shade Dome for Reducing Evaporation of Open Body of Water

(71) Applicant: Christina Zhang, North Logan, UT (US)

(72) Inventor: Christina Zhang, North Logan, UT (US)

(21) Appl. No.: 18/456,498

(22) Filed: Aug. 27, 2023

(51) Int. Cl. E02B 15/08

(52) U.S. Cl. CPC E02B 15/0857; E02B 2201/00

(57) ABSTRACT

The present invention relates to means for substantially reducing evaporation from an open body of water comprising a plurality of domes which cover the surface of the water. The domes are hollow with a predetermined buoyancy for maximum surface coverage and self-stabilization without added weight, and are preferably made of transparent or translucent polycarbonate, high-density polyethylene, or acrylonitrile styrene acrylate, and also having a minimum light intensity of 2700 lux through the dome to sustain organisms living in the open body of water.

### FIELD

The present invention relates to an open body of water surface cover and, more particularly, to a highly efficient and economical float for substantially reducing evaporation from an open body of water surface while sustaining growth and reproduction of organisms living in the body of water.

### BACKGROUND

Various solutions are being sought as water shortages become a serious problem worldwide due to global warming and climate change. A substantial loss of water comes from evaporation due to solar heat. A conventional method of reducing evaporation is covering the water surface with black spherical shade balls made of High-Density Polyethylene. Such shade balls are predominantly used in reservoirs to block sunlight.

Several problems remain with the use of conventional black spherical shade balls. For example, spheres rotate on the surface of the liquid so that the rotating ball carries some of the liquid above the cover of spheres. As a result, a substantial amount of evaporation still occurs. Additionally, for maximum stability, water is pre-filled into the shade balls as additional mass, which counteracts the purpose and results of the shade balls.

U.S. Pat. No. 399,314A contemplates preventing the rotation of such spheres by using floating dodecahedrons with 12 identical pentagonal faces, achieving theoretical 100 percent coverage of the water surface.

Korean patent No. KR102451271B1 uses elliptical balls with body penetration to connect with each other, so a plurality of balls can form a checkerboard shape to prevent ball rotation and separation, making it easier for installation and collection.

Both prior arts introduced internal structures instead of pre-filling water to add mass, thereby floating on the equator on the water surface. However, this increases the material usage for shade ball production, adding cost and environmental impacts. Furthermore, prior use of shade balls in reservoirs focused on preventing growth of organisms in the water to maintain good water quality. Therefore, the shade balls are often carbon black for maximum absorption of sunlight and complete surface coverage is desired.

Neither conventional black spherical shade balls nor prior arts (US and Korean Patents) can be applied in natural open bodies of water, where the pre-existing ecosystem and the organisms living in the water need sunlight and some open water surface to thrive.

As described above, the development of an improved shade ball design capable of solving the problems of conventional design and prior arts is required.

### SUMMARY

According to the present invention, there is provided an open body of water cover including a plurality of floating bodies which substantially eliminates all of the above disadvantages while permitting a uniform covering of the water surface, maximum stability without extra water usage, and sustaining of growth and reproduction of organisms living in the bodies of water. The present cover provides a theoretical 70 percent surface covering.

The present bodies will not rotate, even in the presence of turbulent water, thereby preventing carryover of the liquid to the atmosphere and evaporation. This is achieved with a single layer of bodies so that the increased efficiency is achieved at a much greater economy.

The present floating bodies have a predetermined buoyancy and are designed to rest with the fluid surface on the equator, thereby covering the maximum surface area. The present bodies are preferably hollow.

Briefly, the present cover comprises a plurality of floating domes which substantially cover the surface of the liquid. The domes may be hollow or solid, but are preferably made of transparent or translucent polycarbonate, high-density polyethylene, or acrylonitrile styrene acrylate, and also have a minimum light intensity through the domes of 2700 lux.

### Objects

It is therefore an object of the present invention to provide an open body of water surface cover.

It is further an object of the present invention to provide a highly efficient and economical float for substantially reducing evaporation from an open body of water surface.

It is a further object of the present invention to provide an open body of water surface cover consisting of a plurality of floating domes.

It is another object of the present invention to provide an open body of water surface cover consisting of a plurality of floating domes made from transparent or translucent polycarbonate, high-density polyethylene, or acrylonitrile styrene acrylate.

It is another object of the present invention to provide an open body of water surface cover comprising of a plurality of floating domes, having a minimum light intensity through the domes of 2700 lux.

Another object of the present invention is the provision of an open body of water surface cover comprising of a plurality of bodies where a single layer of such bodies will essentially provide a 70 percent surface cover.

Still other objects, features, and attendant advantages of the present invention will become apparent to those skilled in the art from a reading of the following detailed description of the preferred embodiment constructed in accordance therewith, taken in connection with the accompanying drawings wherein like numerals designate like or corresponding parts in the several figures and wherein:

### BRIEF DESCRIPTION OF THE DRAWINGS

In the following detailed portion of the present description, the teachings of the present application will be explained in more detail with reference to the example embodiments shown in the drawings, in which:

FIG. 1 is a section side view of the individual dome.

FIG. 2 is a perspective side view of a plurality of domes in a body of water.

FIG. 3 is a top view of a plurality of domes in a body of water.

### DETAILED DESCRIPTION OF THE PREFERRED EMBODIMENT

Referring now to the drawings, the present means for providing an open body of water surface cover comprises a plurality of domes.

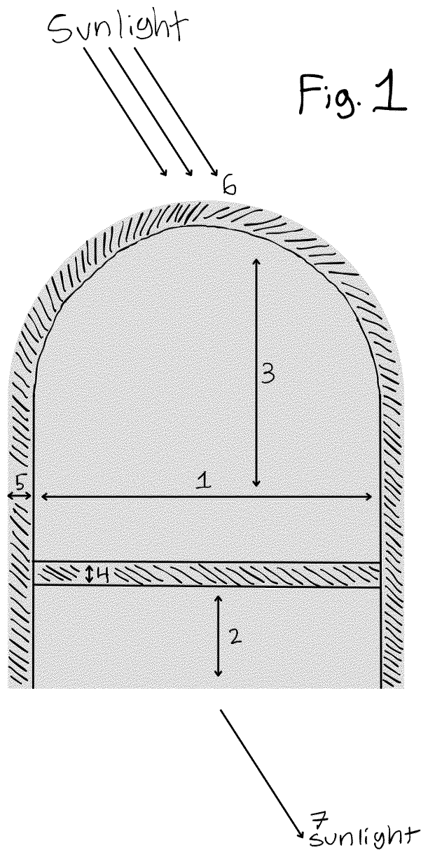

Referring to FIG. 1, each dome is comprised of a hemisphere on top of a cylinder. When there are sufficient bodies to cover the surface, the predetermined buoyancy allows the dome to float with the surface of the water at the maximum diameter 1, and it has been observed and measured that 70 percent of the open surface is covered. This percentage is necessary to account for the organisms living in the bodies of water. Domes may be hollow 5 and include a wall 4 between the hemisphere and cylinder of equal thickness to the outer walls 5. Domes must have uniform density throughout all walls 4, 5. Domes must be made of a material that is resistant to UV exposure and heat 6 preferably from polycarbonate, high-density polyethylene, or acrylonitrile styrene acrylate because they are highly heat and UV resistant and durable. Another unique advantage of domes is the low center of gravity 2 which provides stabilization without additional mass. Thus, any turbulence, vibration, or agitation of the water surface will not cause it to rotate or flip over, preventing more evaporation and reducing usage of water in the production of the invention. According to the preferred embodiment of the present invention, domes must be made of a material that is translucent 6 to allow a minimum light intensity of 2700 lux to pass through the domes to sustain growth of organisms living in bodies of water.

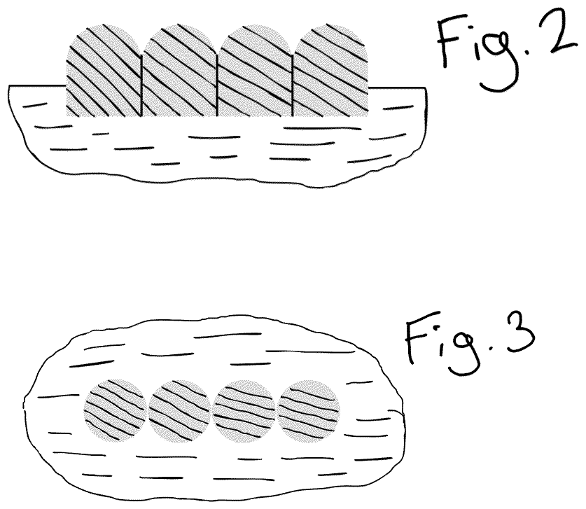

Referring to FIG. 2, any turbulence, vibration, or agitation of the water surface will cause domes to automatically align themselves into a position providing a 70% cover for the surface, assuming a sufficient number of domes are provided.

Referring to FIG. 3, in operation, it is simply necessary to dump a plurality of domes into a body of water, whereupon the floating domes disperse themselves over the surface.

Domes may be produced in any size required for their functions given a uniform density and a predetermined buoyancy.

In general, domes may be used to perform all of the functions of the hollow, spherical devices, but at a generally lower cost due to the minimized water usage and with sustaining growth and reproduction of organisms living in bodies of water.

While the invention has been described with respect to a preferred physical embodiment constructed in accordance therewith, it will be apparent to those skilled in the art that various modifications and improvements may be made without departing from the scope and spirit of the invention. Accordingly, it is to be understood that the invention is not to be limited by the specific illustrative embodiment, but only by the scope of the appended claims.

1. A dome is comprised of a hemisphere on top of a cylinder.

2. The combination of claim 1 wherein said dome is hollow.

3. The combination of claim 2 wherein said dome is made preferably from polycarbonate, high-density polyethylene, or acrylonitrile styrene acrylate.

4. The combination of claim 3 wherein said dome is made of translucent or transparent material.

5. The combination of claim 4 wherein the dome is uniform in density.

6. The combination of claim 5 wherein the minimum light intensity through the dome is 2700 lux.

7. The combination of claim 6 wherein the dome has a predetermined buoyancy.

8. The combination of claim 7 wherein the dome does not require additional mass from water or other materials for stabilization.

9. Means for preventing the evaporation of liquid from the surface thereof comprising: A plurality of domes floating on and substantially covering said surface of water.

10. Means for preventing evaporation of water according to claim 9 wherein said domes are hollow.

11. Means for preventing evaporation of water according to claim 10 wherein said domes are uniform in density.

12. Means for preventing evaporation of water according to claim 11 wherein said domes are hollow.

13. Means for preventing evaporation of water according to claim 12 wherein said domes are made preferably from polycarbonate, high-density polyethylene, or acrylonitrile styrene acrylate.

14. Means for preventing evaporation of water according to claim 13 wherein said domes are made of transparent or translucent material.

15. Means for preventing evaporation of water according to claim 14 wherein the minimum light intensity through the domes is 2700 lux.

16. Means for preventing evaporation of water according to claim 15 wherein said domes have a predetermined buoyancy.
